(19) United States
(12) Patent Application Publication
(10) Pub. No.: US 2008/0055672 A1
(43) Pub. Date: Mar. 6, 2008

(54) OPTICAL SCANNING DEVICE AND IMAGE FORMING APPARATUS

(76) Inventors: Naoto WATANABE, Kanagawa (JP); Shunichi Sato, Miyagi (JP); Daisuke Ichii, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/845,409

(22) Filed: Aug. 27, 2007

(30) Foreign Application Priority Data
Sep. 4, 2006 (JP) 2006-239563

(51) Int. Cl. H04N 1/04

(52) U.S. Cl. 358/474

(57) ABSTRACT

A two-dimensional array include N light-emitting arrays each formed of M light-emitting units arranged equally spaced along a direction T tilting from a main scanning direction at an angle α toward a sub-scanning direction. The light-emitting arrays are equally spaced in the sub-scanning direction. A space ds2 between light-emitting arrays with respect to the sub-scanning direction satisfies ds2=ds1×M where ds1 is a positional difference in the sub-scanning direction between light-emitting units which are adjacent each other in the main scanning direction and orthographically-projected on a virtual line extending in the sub-scanning direction. The angle α satisfies α=sin⁻¹((ds2/d1)/M) where d1 is a space between light-emitting units in the light-emitting array with respect to the direction T. The space ds2 is equal to the space d1.

### CROSS-REFERENCE TO RELATED APPLICATIONS

The present application claims priority to and incorporates by reference the entire contents of Japanese priority document, 2006-239563 filed in Japan on Sep. 4, 2006.

### BACKGROUND OF THE INVENTION

1. Field of the Invention

The present invention relates to an optical scanning device, and an image forming apparatus.

2. Description of the Related Art

In image recording of electrophotography, image forming apparatuses using a laser are widely used. Such image forming apparatuses generally include an optical scanning device that scans laser light using a polygon scanner (e.g., polygon mirror) in an axial direction of a rotating photosensitive drum to form a latent image. In the field of electrophotography, an increase in density of images to improve image quality and an increase in speed of image output to improve operability have been desired for image forming apparatuses.

One approach to achieving high-density as well as high-speed involves rotating the polygon scanner at high speed. In this case, however, noise at the polygon scanner is increased, power consumption is increased, and durability is decreased.

Another approach can be multibeaming of light beams emitted from a light source. Such multibeam can be acquired by the following schemes: (1) combining a plurality of edge emitting lasers as disclosed in, for example, Japanese Patent Application Laid-Open No. 2005-250319; (2) using a one-dimensional array of edge emitting lasers; and (3) using a two-dimensional array of vertical-cavity surface-emitting lasers (VCSELs).

In scheme (1), general-purpose lasers can be used, and therefore, low cost can be achieved. However, it is difficult to stably keep a relative position between the lasers and a coupling lens with the use of the plurality of beams. This possibly causes space (hereinafter, “scanning-line space”) to be non-uniform among a plurality of scanning lines formed on a surface to be scanned. Moreover, in scheme (1), the number of light sources practically has a limitation, and therefore, the increases of density and speed have also limitations. In scheme (2), although the scanning-line space can be made uniform, power consumption of elements is increased. Moreover, if the number of light sources is substantially increased, the amount of shift of the beam from the optical axis of the optical system is increased. This possibly causes a deterioration in beam quality.

On the other hand, in scheme (3), power consumption is smaller than that of the edge emitting laser by approximately one digit, which allows more light sources to be easily integrated in a two-dimensional manner.

For example, Japanese Patent Application Laid-Open No. H10-301044 discloses a conventional multibeam scanning device using a two-dimensional array of VCSELs as a light source. In the conventional multibeam scanning device, a two-dimensional array is used in which a plurality of light-emitting sources are arranged in a matrix along two directions perpendicular to each other, thereby being rotatable around the optical axis.

FIGS. 13A and 13B are schematic diagram for explaining the conventional two-dimensional array of VCSELs. For convenience, two directions perpendicular to each other are referred to as direction D1 and direction D2. As in the conventional multibeam scanning device, if the two-dimensional array as shown in FIG. 13A is rotated around the optical axis, as shown in FIG. 13B, the direction D1 and the direction D2 are tilted with respect to a main scanning direction and a sub-scanning direction, respectively (in FIG. 13B, by a tilt angle α). In a plurality of light-emitting sources disposed along the direction D1 (e.g., v1 to v4), positions in the main scanning direction are different from each other. In particular, light-emitting sources at both ends (e.g., v1 and v4) have a large amount of shift therebetween in the main scanning direction (in FIG. 13B, Δd). In this manner, if the plurality of light-emitting sources disposed along the direction D1 are different in position in the main scanning direction, the width of the entire light beams directed to a deflection reflecting surface of an optical deflector is increased, which possibly causes a deterioration in beam quality. Moreover, because the light-emitting sources disposed along the direction D1 are different in position in the main scanning direction, the plurality of light-emitting sources disposed along the direction D1 have to be simultaneously lit to independently perform a synchronization detection for each scanning line. However, in this case, the amount of light is not sufficient or a beam for use in synchronization detection is thickened in the main scanning direction. Thus, it is difficult to perform accurate synchronization detection.

### SUMMARY OF THE INVENTION

It is an object of the present invention to at least partially solve the problems in the conventional technology.

According to an aspect of the present invention, an optical scanning device includes a light source that includes a two-dimensional array of light-emitting units, and an optical system that scans a target surface with light beams from the light source. The two-dimensional array include N light-emitting arrays each formed of M light-emitting units arranged equally spaced along a first direction. The first direction tilts from a main scanning direction at an angle α toward a sub-scanning direction. The light-emitting arrays are equally spaced in the sub-scanning direction. A space ds2 between adjacent light-emitting arrays with respect to the sub-scanning direction satisfies ds2=ds1×M where ds1 is a space or a positional difference in the sub-scanning direction between light-emitting units adjacent each other in the main scanning direction in the light-emitting array orthographically-projected on a virtual line extending in the sub-scanning direction. The angle α satisfies α=sin⁻¹ ((ds2/d1)/M) where d1 is a space between adjacent light-emitting units in the light-emitting array with respect to the first direction.

According to another aspect of the present invention, an optical scanning device includes a light source that includes a two-dimensional array of light-emitting units, and an optical system that scans a target surface with light beams from the light source. The two-dimensional array include N light-emitting arrays each formed of M light-emitting units arranged equally spaced along a first direction. The first direction tilts from a main scanning direction at an angle α toward a sub-scanning direction. The light-emitting arrays are equally spaced in the sub-scanning direction, and alternately extend in the first direction from a first position and a second position. A space ds2 between adjacent light-emitting arrays with respect to the sub-scanning direction satisfies ds2=ds1×M where ds1 is a space or a positional difference in the sub-scanning direction between light-emitting units adjacent each other in the main scanning direction in the light-emitting array orthographically-projected on a virtual line extending in the sub-scanning direction. The angle α satisfies α=sin⁻¹((ds2/d1)/M) where d1 is a space between adjacent light-emitting units in the light-emitting array with respect to the first direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a laser printer according to an embodiment of the present invention;

FIGS. 2 and 3 are schematic diagrams of an optical scanning device shown in FIG. 1;

FIG. 4 is a schematic diagram of a two-dimensional array of VCSELs in a light source shown in FIGS. 2 and 3;

FIG. 5 is a schematic diagram of each VCSEL in the two-dimensional array shown in FIG. 4;

FIG. 6 is a partially-enlarged view of the VCSEL shown in FIG. 5;

FIG. 7 is a schematic diagram of a first modification of the two-dimensional array of VCSELs;

FIG. 8 is a schematic diagram of a second modification of the two-dimensional array of VCSELs;

FIG. 9 is a schematic diagram of each VCSEL in the two-dimensional array of VCSELs shown in FIG. 8;

FIG. 10 is a partially-enlarged view of the VCSEL shown in FIG. 9;

FIG. 11 is a schematic diagram for explaining characteristics of the VCSEL shown in FIG. 9;

FIG. 12 is a schematic diagram of a tandem color printer; and

FIGS. 13A and 13B are schematic diagram for explaining a conventional two-dimensional array of VCSELs.

### DETAILED DESCRIPTION OF THE PREFERRED EMBODIMENTS

Exemplary embodiments of the present invention are explained below in detail with reference to the accompanying drawings.

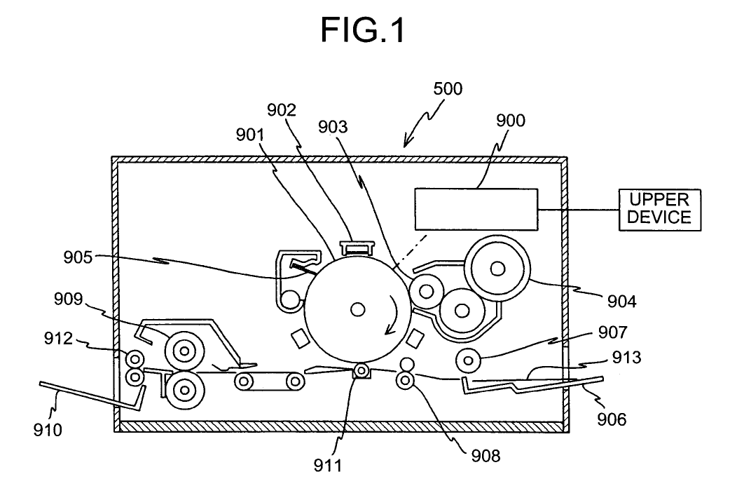

FIG. 1 is a schematic diagram of a laser printer 500 as an image forming apparatus according to an embodiment of the present invention. In the following, the “space” refers to a distance between centers of two light-emitting units.

The laser printer 500 includes an optical scanning device 900, a photosensitive drum 901 as an image carrier, a charger 902, a developing roller 903, a toner cartridge 904, a cleaning blade 905, a sheet-feed tray 906, a sheet-feed roller 907, a registration roller pair 908, a transfer charger 911, a fixing roller 909, a sheet-discharge roller 912, and a sheet-discharge tray 910.

The charger 902, the developing roller 903, the transfer charger 911, and the cleaning blade 905 are disposed near the surface of the photosensitive drum 901. With respect to a rotating direction of the photosensitive drum 901 (direction indicated by an arrow in FIG. 1), the charger 902, the developing roller 903, the transfer charger 911, and the cleaning blade 905 are disposed in this order.

On the surface of the photosensitive drum 901 is formed a photosensitive layer. That is, the surface of the photosensitive drum 901 is a target surface (target surface). The charger 902 uniformly charges the surface of the photosensitive drum 901.

The optical scanning device 900 exposes the surface of the photosensitive drum 901 charged by the charger 902 to modulated light based on image information from an upper device (e.g., a personal computer). With this, on the surface of the photosensitive drum 901, electric charges are removed from a portion exposed to the light, and a latent image corresponding to the image information is formed on the surface of the photosensitive drum 901. The latent image is moved according to the rotation of the photosensitive drum 901 in a direction of the developing roller 903. The longitudinal direction (direction along the rotating axis) of the photosensitive drum 901 is referred to as a “main scanning direction”, whilst the rotating direction of the photosensitive drum 901 is referred to as a “sub-scanning direction”. The optical scanning device 900 is described further below.

The toner cartridge 904 contains toner supplied to the developing roller 903. The amount of toner in the toner cartridge 904 is checked at the time of power on, at the end of printing, and the like. When the amount of remaining toner is low, a message for replacement is displayed on a display unit (not shown).

To the surface of the developing roller 903 is attached charged toner supplied from the toner cartridge 904 according to its rotation. The toner is attached to the surface thinly and uniformly. Also, to the developing roller 903, a voltage is applied so that electric fields opposite to each other are generated on a charged portion (portion not exposed to light) and a uncharged portion (portion exposed to light) of the photosensitive drum 901. With this voltage, the toner attached on the surface of the developing roller 903 is attached only to the portion exposed to light on the surface of the photosensitive drum 901. That is, from the photosensitive roller 903, the toner is attached to the latent image formed on the surface of the photosensitive drum 901 to visualize the image information. The latent image on which the toner is attached is moved in a direction of the transfer charger 911 with the rotation of the photosensitive drum 901.

The sheet-feed tray 906 has stored therein recording sheets 913 as transfer targets. Near the sheet-feed tray 906, the sheet-feed roller 907 is disposed. The sheet-feed roller 907 takes out the recording sheets 913 one by one from the sheet-feed tray 906 for conveyance to the registration roller pair 908. The registration roller pair 908 is disposed near the transfer charger 911 for temporarily holding the recording sheet 913 taken out by the sheet-feed roller 907 and then sending out the recording sheet 913 to a gap between the photosensitive drum 901 and the transfer charger 911 according to the rotation of the photosensitive drum 901.

To the transfer charger 911, a voltage having a polarity opposite to the polarity of the photosensitive drum 901 is applied to cause the toner on the surface of the photosensitive drum 901 to be electrically attracted to the recording sheet 913. With this voltage, the latent image on the surface of the photosensitive drum 901 is transferred onto the recording sheet 913. Here, the transferred recording sheet 913 is sent to the fixing roller 909.

The fixing roller 909 applies heat and pressure to the recording sheet 913, thereby fixing the toner onto the recording sheet 913. The recording sheet 913 is then sent via the sheet-discharge roller 912 to the sheet-discharge tray 910 and is stacked thereon.

The cleaning blade 905 removes the toner left on the surface of the photosensitive drum 901 (residual toner). The removed residual toner is to be reused. The surface of the photosensitive drum 901 with the residual toner removed therefrom returns to the position of the charger 902 again.

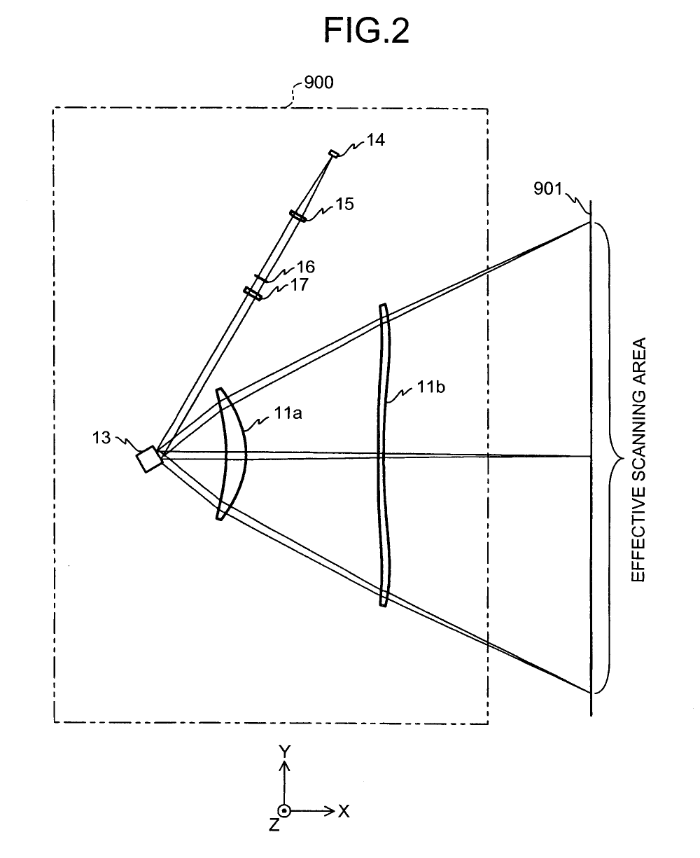

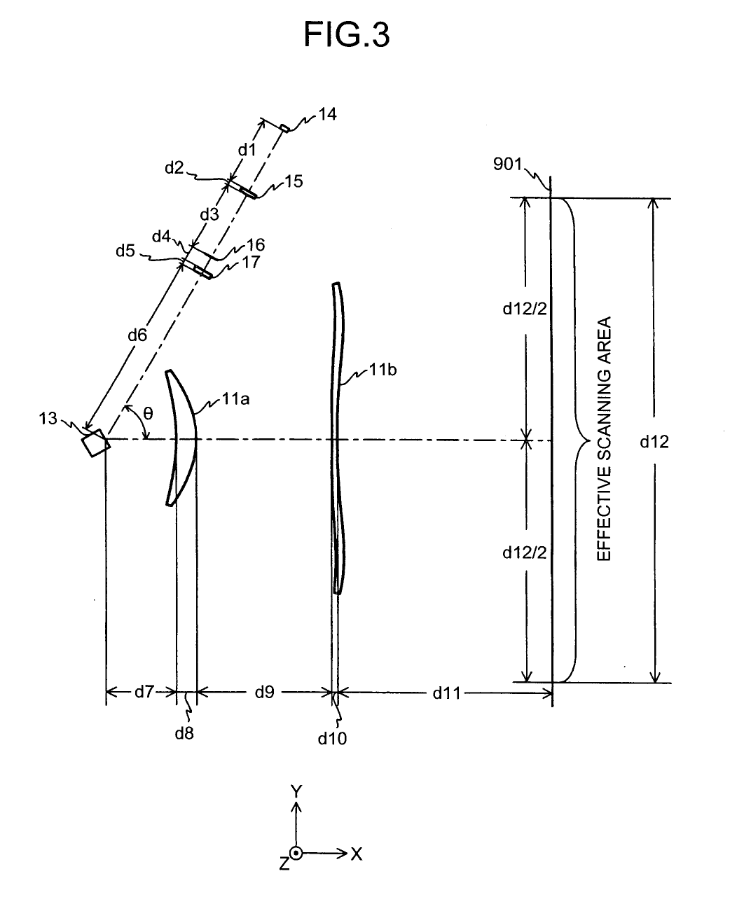

Next, the optical scanning device 900 is explained with reference to FIGS. 2 and 3.

The optical scanning device 900 includes a light source 14, a coupling lens 15, an aperture 16, a cylindrical lens 17 as a line-image forming lens, a polygon mirror 13 as an optical deflector, a polygon motor (not shown) for rotating the polygon mirror 13, and two scanning lenses (11a and 11b).

The coupling lens 15 is, for example, a lens made of glass having a focal length of 46. 5 millimeters and a thickness (d2 in FIG. 3) of 3.0 millimeters, and renders a light beam emitted from the light source 14 as approximately parallel light.

The aperture 16 has, for example, a rectangle or oval opening portion having a front width of 5.44 millimeters in a direction corresponding to the main scanning direction and a front width of 2.2 millimeters in a direction corresponding to the sub-scanning direction, and defines a beam diameter of the light beam passing through the coupling lens 15.

The cylindrical lens 17 is, for example, a lens made of glass having a focal length of 106.9 millimeters and a thickness (d5 in FIG. 3) of 3.0 millimeters, and forms an image in the sub-scanning direction near the deflection reflecting surface of the polygon mirror 13 from out of the light beam passing though the opening portion of the aperture 16.

The polygon mirror 13 is, for example, a quadruple mirror having an inradius of 7 millimeters, and rotates with constant velocity around an axis parallel to the sub-scanning direction.

The scanning lens 11a is, for example, a lens made of resin having a center (on the optical axis) thickness (d8 in FIG. 3) of 13.50 millimeters.

The scanning lens 11b is, for example, a lens made of resin having a center (on the optical axis) thickness (d10 in FIG. 3) of 3.50 millimeters.

An optical system disposed on an optical path between the light source 14 and the polygon mirror 13 is also referred to as a coupling optical system. In the present embodiment, for example, the coupling optical system is configured of the coupling lens 15, the aperture 16, and the cylindrical lens 17.

An optical system disposed on an optical path between the polygon mirror 13 and the photosensitive drum 901 is also referred to as a scanning optical system. In the present embodiment, for example, the scanning optical system is configured of the scanning lens 11a and the scanning lens 11b.

The lateral magnification in the sub-scanning direction of this scanning optical system is, for example, 0.97. Also, the lateral magnification in the sub-scanning direction of the entire optical system of the optical scanning device 900 is, for example, 2.2.

In the present embodiment, a target diameter of an optical spot formed on the surface of the photosensitive drum 901 is, for example, 52 micrometers in the main scanning direction and 55 micrometers in the sub-scanning direction.

Also, for example, the distance between the light source 14 and the coupling lens 15 (d1 in FIG. 3) is 46.06 millimeters, the distance between the coupling lens 15 and the aperture 16 (d3 in FIG. 3) is 47.69 millimeters, the distance between the aperture 16 and the cylindrical lens 17 (d4 in FIG. 3) is 10.32 millimeters, and the distance between the cylindrical lens 17 and the polygon mirror 13 (d6 in FIG. 3) is 128.16 millimeters.

Furthermore, the distance between the polygon mirror 13 and a first surface (plane of incidence) of the scanning lens 11a (d7 in FIG. 3) is 46.31 millimeters, the distance between a second surface (plane of emittance) of the scanning lens 11a and a first surface (plane of incidence) of the scanning lens 11b (d9 in FIG. 3) is 89.73 millimeters, and the distance between a second surface (plane of emittance) of the scanning lens 11b and the surface of the photosensitive drum 901, which is a target surface, (d11 in FIG. 3) is 141.36 millimeters.

Still further, the length of an effective scanning area in the photosensitive drum 901 (d12 in FIG. 3) is 323 millimeters. Still further, an angle θ in FIG. 3 is 60 degrees.

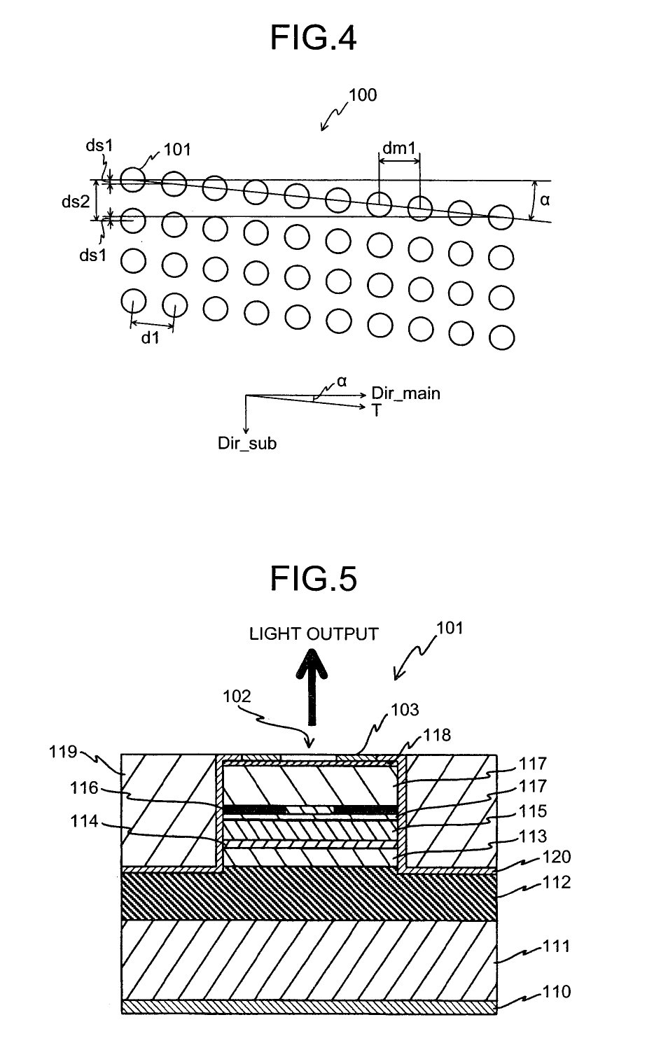

The light source 14 has a two-dimensional array 100 in which, as depicted in FIG. 4, for example, 40 light-emitting units 101 are formed on one substrate. The two-dimensional array 100 includes four light-emitting arrays, each row having disposed therein 10 light-emitting units equally spaced along a direction forming the tilt angle α (hereinafter, “direction T”) with respect to a direction corresponding to the main scanning direction (hereinafter, “direction Dir_main”) toward a direction corresponding to the sub-scanning direction (hereinafter, “direction Dir_sub”). These four light-emitting arrays are arranged equally spaced in the direction Dir_sub. That is, 40 light-emitting units are two-dimensionally arranged along the direction T and the direction Dir_sub.

For example, the space between adjacent light-emitting arrays in the direction Dir_sub (ds2 in FIG. 4) is 24.0 micrometers, the space between light-emitting units in the direction T in each light-emitting arrays (d1 in FIG. 4) is 24.0 micrometers, and a space between light-emitting units orthographically-projected on a virtual line extending in the direction Dir_sub (ds1 in FIG. 4) is 2.4 micrometers. That is, a relation of ds2=d1 and ds2=ds1×M holds.

Furthermore, for example, the tilt angle α is 5.74 degrees. That is, α=sin⁻¹((ds2/d1)/M).

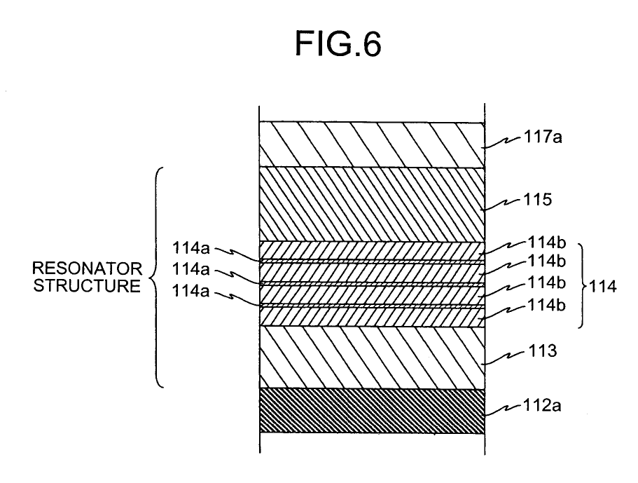

Each light-emitting unit is a VCSEL of a 780-nanometer band. As shown in FIG. 5, for example, on an n-GaAs substrate 111 are stacked semiconductor layers, i.e., a lower reflecting mirror 112, a spacer layer 113, an active layer 114, a spacer layer 115, an upper reflecting mirror 117, and a p-contact layer 118. In the following, a structure of a plurality of such semiconductor layers stacked one upon another is referred to as a “multilayered structure”. An enlarged view of a portion near the active layer 114 is depicted in FIG. 6.

The lower reflecting mirror 112 has 40.5 pairs of a low refractive index layer 112a made of n-Al_{0.9}Ga_{0.1}As and a high refractive index layer 112b made of n-Al_{0.9}Ga_{0.7}As. Any refractive index layer is set to have an optical thickness of λ/4 where λ is an oscillation wavelength. A composition-tilted layer (not shown) in which the composition is gradually varied from one composition to another composition is provided between the lower refractive index layer 112a and the high refractive index layer 112b to reduce electric resistance.

The spacer layer 113 is a layer made of Al_{0.9}Ga_{0.4}As.

The active layer 114 has a quantum well layer 114a made of Al_{0.12}Ga_{0.99}As and a barrier wall layer 114b made of Al_{0.3}Ga_{0.7}As (refer to FIG. 6).

The spacer layer 115 is made of Al_{0.9}Ga_{0.4}As. A portion formed of the spacer layer 113, the active layer 114, and the spacer layer 115 is referred to as a resonator structure, and is set to have 1 wavelength optical thickness (refer to FIG. 6).

The upper reflecting mirror 117 has 24 pairs of a low refractive index layer 117a made of p-Al_{0.9}Ga_{0.1}As and a high refractive index layer 117b made of p-Al_{0.3}Ga_{0.7}As. Any refractive index layer is set to have an optical thickness of λ/4. A composition-tilted layer (not shown) in which the composition is gradually varied from one composition to another composition is provided between the lower refractive index layer 117a and the high refractive index layer 117b to reduce electric resistance.

At a position λ/4 away from the resonator structure in the upper reflecting mirror 117, a selected oxide layer 116 made of AlAs is provided.

Next, a method of manufacturing the two-dimensional array 100 is briefly explained.

(1) The multilayered structure is formulated through crystal growth using metal organic chemical vapor deposition (MOCVD) method or molecular beam epitaxy (MBE) method.

(2) A trench is formed through dry etching around each of a plurality of areas serving as light-emitting units to form a so-called mesa portion. An etching bottom surface is set to reach the inside of the lower reflecting mirror 112. Note that the etching bottom surface can be anywhere as long as it goes over the selected oxide layer 116. With this, the selected oxide layer 116 appears on a side wall of the trench. Also, the dimension (diameter) of the mesa portion is preferably equal to or greater than 10 micrometers. If the dimension is too small, heat is accumulated at the time of element operation, which may adversely affect light-emitting characteristics.

(3) The multilayered structure with the trenches formed therein is subjected to a heat treatment in water vapor, and a portion around the selected oxide layer 116 in the mesa portion is selectively oxidized to be changed into an insulator layer of AlₓO_{y}. Then, an AlAs area not oxidized on the selected oxide layer 116 is left at the center portion of the mesa portion. With this, a so-called electric-current narrowing structure is formed in which the path for a driving current of the light-emitting unit is restricted only to the center portion of the mesa portion.

(4) A SiO₂ protective layer 120 having a thickness of, for example, 150 nanometers, is provided to an area except an area where an upper electrode 103 of each mesa portion is to be formed and a light-emitting unit 102. Furthermore, polyimide 119 is buried in each trench for planarization.

(5) The upper electrode 103 is formed on an area except the light-emitting unit 102 on the p-contact layer 118 in each mesa portion. Also, a bonding pad (not shown) is formed around the multilayered structure. Furthermore, wires (not shown) connecting each upper electrode 103 and its corresponding bonding pad is formed.

(6) A lower electrode (n-side common electrode) 110 is formed on a back surface of the multilayered structure.

(7) The multilayered structure is cut into a plurality of chips.

As evident from the explanation above, in the laser printer 500 according to the present embodiment, the charger 902, the developing roller 903, the toner cartridge 904, and the transfer charger 911 form a transfer device.

As explained above, in the optical scanning device 900, the light source 14 includes four light-emitting arrays, each including 10 (M) light-emitting units equally spaced along the direction T forming a tilt angle α with respect to the direction Dir_main toward the direction Dir_sub. That is, such a relation holds that the number of light-emitting arrays is smaller than the number of light-emitting units forming one light-emitting array. The light-emitting arrays are arranged equally spaced in the direction Dir_sub, and the space ds2 between adjacent light-emitting arrays with respect to the direction Dir_sub is equal to the space d1 between light-emitting units in each light-emitting array with respect to the direction T. The space ds2 satisfies a relation of ds2=ds1×M where ds1 is a space or a positional difference in the direction Dir_sub between light-emitting units adjacent each other in the direction Dir_main orthographically-projected on a virtual line extending in the direction Dir_sub. The tilt angle α=sin⁻¹((ds2/d1)/M1).

With this, the plurality of light-emitting units are equally spaced along the direction Dir_sub as well as the direction Dir_main, which suppresses an increase in width of all light beams that enter the scanning optical system. As a result, beam quality can be prevented from being deteriorated. Moreover, an independent synchronization detection is not required for each scanning line, and therefore, accuracy in synchronization detection can be prevented from being impaired. Therefore, optical scanning with high density can be achieved without inviting a deterioration in beam quality or a decrease in accuracy of detecting synchronization.

In the two-dimensional array 100 with a wide space between VCSELs, a thermal influence (thermal interference) from other VCSELs can be suppressed, which enables stable optical scanning.

The laser printer 500 includes the optical scanning device 900 capable of optical scanning with high density without inviting a deterioration in beam quality or a decrease in accuracy of detecting synchronization. As a result, an image with high quality can be formed at high speed.

In the above embodiment, when a large temperature change is expected, at least one of the scanning lens 11a and the scanning lens 11b can have formed thereon a diffraction grating for suppressing a deterioration in optical characteristic due to temperature changes.

Also, in the above embodiment, both of the coupling lens 15 and the cylindrical lens 17 are made of glass. However, at least one of the coupling lens 15 and the cylindrical lens 17 can be made of resin to reduce cost. When a large temperature change is expected, in place of a lens made of resin, a diffraction optical element capable of suppressing a deterioration in optical characteristic due to temperate changes is preferable for use.

In the above embodiment, the shape of each mesa portion in the two-dimensional array 100 is circular. However, the mesa portion can be in any shape such as oval, square, or rectangle.

In the above embodiment, 10 light-emitting units form each of four light-emitting arrays. However, the number of light-emitting units as well as light-emitting arrays is arbitrary as long as it satisfies a relation “the number of light-emitting units forming one light-emitting array”>“the number of light-emitting arrays”.

Further, in the above embodiment, the space ds2 and the space d1 between light-emitting units are equal to each other. However, for example, when thermal interference is required to be further reduced, the space d1 between light-emitting units can be widened to satisfy ds2/d1=0/8. In this case, the tilt angle α is 4.59 degrees. With this, thermal interference can be further reduced with the scanning density being maintained.

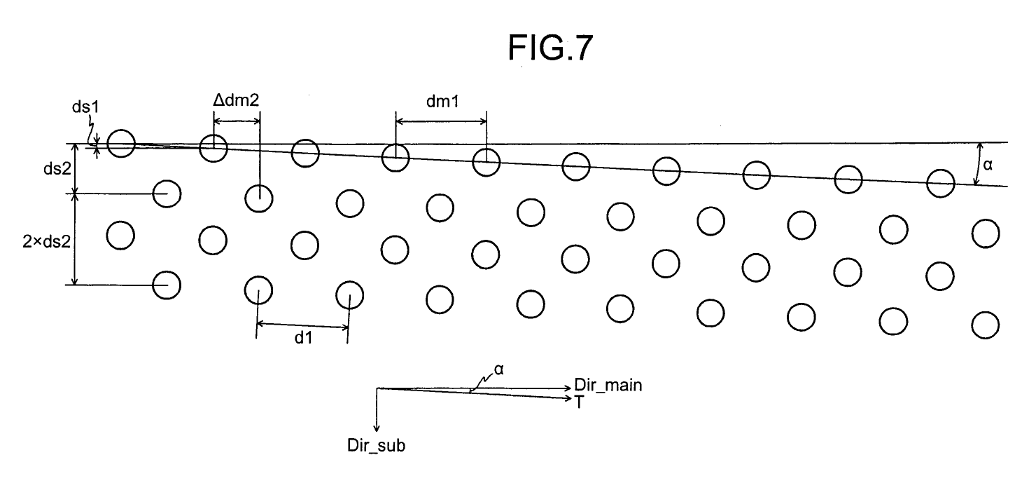

When thermal interference is required to be further reduced with maintaining the scanning density, as shown in FIG. 7, for example, in the four light-emitting arrays, the positions with respect to the direction T cay be varied between odd-numbered light-emitting arrays and even-numbered rows thereof. In this case, a difference in position (Δdm2 in FIG. 7) can be ½ times the space between light-emitting units (dm1 in FIG. 7) of a light-emitting array orthographically-projected on the virtual line extending in the direction Dir_main. For example, to maintain the space ds2=24.0 micrometers and the space between light-emitting units ds1=2.4 micrometers, all that is required is the space between light-emitting units dm1=47.8 micrometers, the difference in position Δdm2=23.9 micrometers, the space d1 between light-emitting units=48 micrometers, and the tilt angle α=2.86 degrees. In this case, the space ds2×2=the space d1 between light-emitting units.

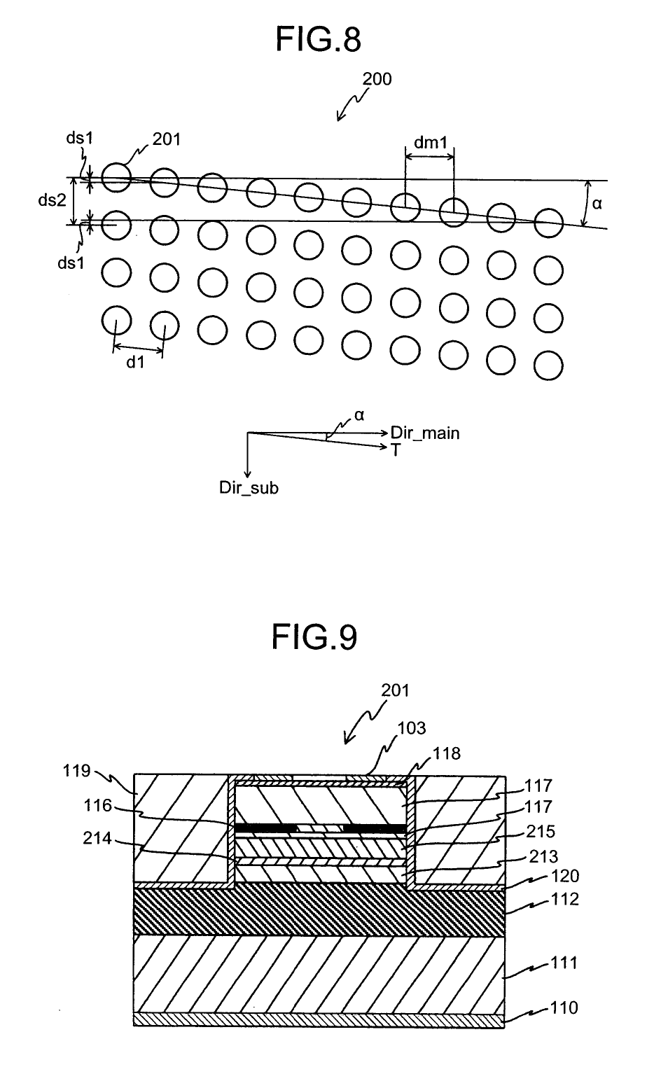

Still further, in the above embodiment, as shown in FIGS. 8 to 10, for example, in place of the two-dimensional array 100, a two-dimensional array 200 can be used with part of material of the plurality of semiconductor layers forming the two-dimensional array 200 being changed. In the two-dimensional array 200, the spacer layer 113 in the two-dimensional array 100 is changed to a spacer layer 213, the active layer 114 is changed to an active layer 214, and the spacer layer 115 is changed to a spacer layer 215.

The spacer layer 213 is a wide bandgap layer made of (Al_{0.7}Ga_{0.3})_{0.5}In_{0.5}P.

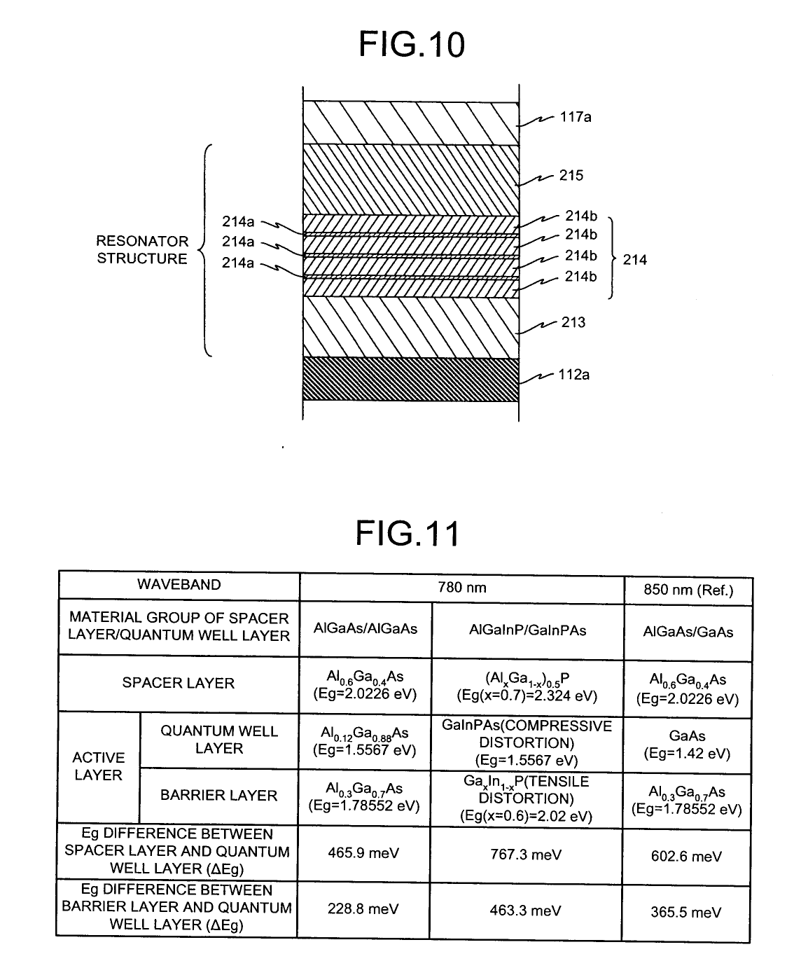

The active layer 214 has three GaInPAs quantum well layers 214a having a composition in which a compressed distortion remains and having a bandgap wavelength of 780 nanometers and four barrier layers 214b made of Ga_{0.6}In_{0.4}P having a tensile distortion (refer to FIG. 10).

The spacer layer 215 is a wide bandgap layer made of (Al_{0.7}Ga_{0.3})_{0.5}In_{0.5}P.

The portion formed of the spacer layer 213, the active layer 214, and the spacer layer 215 is referred to as a resonator structure, and its thickness is set to have 1 wavelength optical thickness.

In the two-dimensional array 200, the material of an AlGaInP group is used for the spacer layers. Therefore, compared with the two-dimensional array 100 in the embodiment described above, a large bandgap difference between the spacer layer and the active layer can be taken.

FIG. 11 is a table of energy bandgap (Eg) difference between the spacer layer and the quantum well layer and energy bandgap (Eg) difference between the barrier layer and the quantum well layer with a typical material composition regarding a VCSEL in which the material of the spacer layer/quantum well layer is of an AlGaAs/AlGaAs group and its wavelength is in 780-nanometer band (hereinafter, “VCSEL_A”), a VCSEL in which the material of the spacer layer/quantum well layer is of an AlGaInP/GaInPAs group and its wavelength is in 780-nanometer band (hereinafter, “VCSEL_B”), a VCSEL in which the material of the spacer layer/quantum well layer is of an AlGaAs/GaAs group and its wavelength is in 850-nanometer band (hereinafter, “VCSEL_C”). VCSEL_A corresponds to the VCSEL 101 in the two-dimensional array 100, whilst VCSEL_B with x=0.7 corresponds to the VCSEL 201 in the two-dimensional array 200.

According to this table, it can be known that the VCSEL_B can take a larger bandgap different than the VCSEL_A as well as the VCSEL_C. Specifically, the bandgap difference between the spacer layer and the quantum well layer is 767.3 million electron volts, which is extremely large compared with 465.9 million electron volts for the VCSEL_A. Similarly, the VCSEL_B has superiority in the bandgap difference between the barrier layer and the quantum well layer. Thus, further excellent carrier confinement can be achieved.

In the VCSEL 201, since the quantum well layer has a compressive distortion, an increase in gain is large due to band separation of a heavy hole and a light hole to cause a high gain. Therefore, a high output can be achieved with a low threshold. For this reason, a reduction in reflectivity of the reflecting mirror on a light extracting side (the upper reflecting mirror 117) can be achieved, resulting in a higher output. With the achievement of a high gain, a decrease in optical output due to a temperature rise can be suppressed, whereby the space between VCSELs can be further narrowed.

In the VCSEL 201, both of the quantum well layer 214a and the barrier layer 214b are made of a material not containing aluminum (Al). Therefore, an intake of oxygen into the active layer 214 is reduced. As a result, the formation of a non-radiative recombination center can be suppressed, which further prolongs the life of the VCSEL.

Meanwhile, for example, when a two-dimensional array of VCSELs is used for a so-called write optical unit, if the life of the VCSELs is short, the write optical unit is of a disposal one. However, since the VCSEL 201 has a long life as explained above, the write optical unit using the two-dimensional array 200 is reusable. Therefore, resource protection can be promoted, and the load on the environment can be reduced. The same goes for other devices using the two-dimensional array of VCSELs.

In the above embodiment, the image forming apparatus is explained as being a laser printer. However, the optical scanning device can be provided to any image forming apparatus to enable a high quality image to be formed at high speed with.

Also, even an image forming apparatus for forming color images can form a high-definition image at high speed by using an optical scanning device that supports color images.

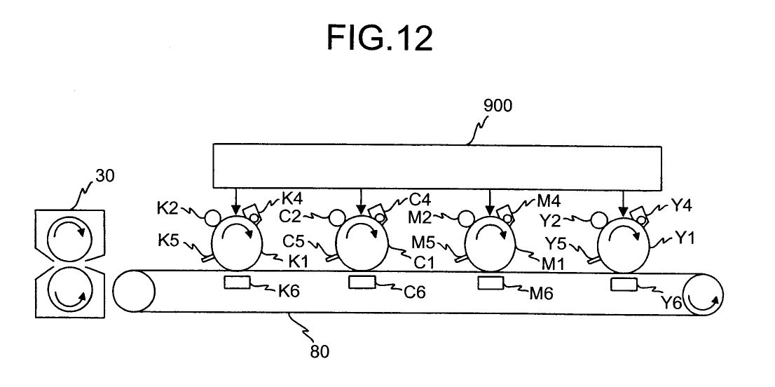

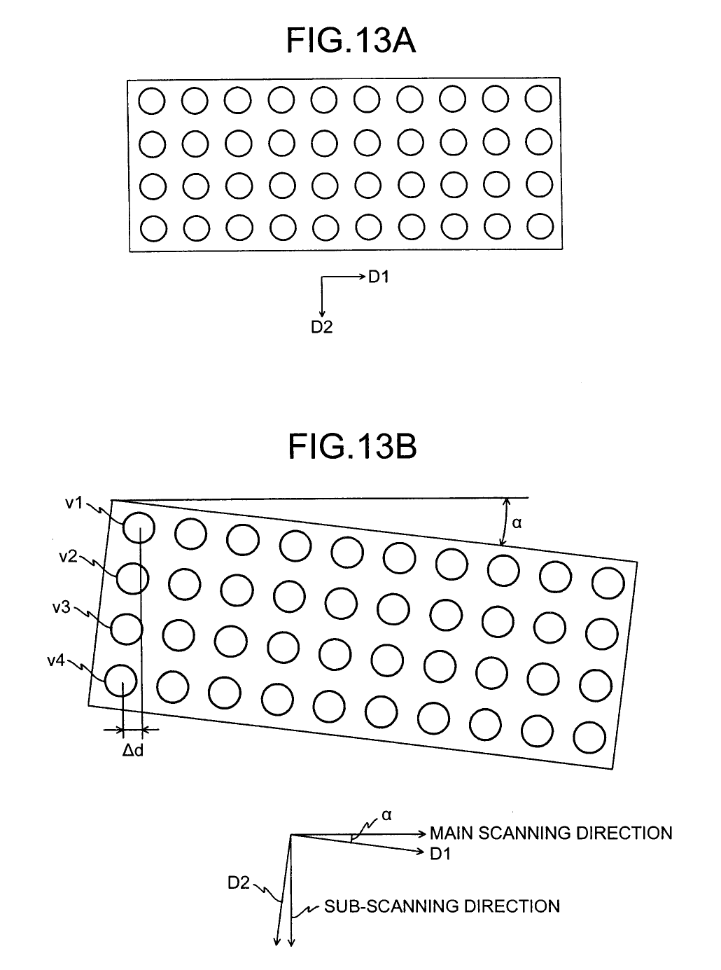

FIG. 12 is a schematic diagram of a tandem color printer as an example of the image forming apparatus. The tandem color printer includes a plurality of photosensitive drums for forming color images. The tandem color printer includes a photosensitive drum K1, a charger K2, a developer K4, a cleaning unit K6, and a transfer charging unit K6 for black (K); a photosensitive drum C1, a charger C2, a developer C4, a cleaning unit C5, and a transfer charging unit C6 for cyan (C); a photosensitive drum M1, a charger M2, a developer M4, a cleaning unit M5, and a transfer charging unit M6 for magenta (M); a photosensitive drum Y1, a charger Y2, a developer Y4, a cleaning unit Y5, and a transfer charging unit Y6 for yellow (Y); the optical scanning device 900, a transfer belt 800, and a fixing unit 30.

In this case, in the optical scanning device 900, the plurality of VCSELs in the two-dimensional array 100 (or the two-dimensional array 200) are divided into those for black, cyan, magenta, and yellow. The photosensitive drum K1 is exposed to an optical beam from each VCSEL for black, the photosensitive drum C1 is exposed to an optical beam from each VCSEL for cyan, the photosensitive drum M1 is exposed to an optical beam from each VCSEL for magenta, and the photosensitive drum Y1 is exposed to an optical beam from each VCSEL for yellow. The optical scanning device 900 may include separate two-dimensional array 100 (or two-dimensional array 200) for each color. Also, the optical scanning device 900 may be provided for each color.

Each photosensitive drum rotates in a direction indicated by an arrow in FIG. 12, and the charger, the developer, the transfer charging unit, and the cleaning unit are disposed in the rotation order. Each charger uniformly charges the surface of the corresponding photosensitive drum. The surface of the photosensitive drum charged by the charger is exposed to light beams by the optical scanning device 900. Accordingly, an electrostatic latent image is formed on the photosensitive drum. Then, with the corresponding developer, a toner image is formed on the surface of the photosensitive drum. Furthermore, with the corresponding transfer charging unit, a toner image of each color is transferred onto a recording sheet. Finally, with the fixing unit 30, an image is fixed onto the recording sheet.

In the tandem color printer, a color shift may occur due to machine inaccuracy or the like. In the optical scanning device 900, however, VCSELs to be lit are selected from a high-density two-dimensional array of VCSELs. Thus, color shift can be corrected for each color with high accuracy.

According to an embodiment of the present invention, an increase in width of the entire light beam entering the optical system that scans the target surface can be suppressed. As a result, high-density optical scanning can be achieved without inviting a deterioration in beam quality or a decrease in accuracy of detecting synchronization.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An optical scanning device comprising:
a light source that includes a two-dimensional array of light-emitting units; and
an optical system that scans a target surface with light beams from the light source, wherein
the two-dimensional array include N light-emitting arrays each formed of M light-emitting units arranged equally spaced along a first direction, the first direction tilting from a main scanning direction at an angle α toward a sub-scanning direction,
the light-emitting arrays are equally spaced in the sub-scanning direction,
a space ds2 between adjacent light-emitting arrays with respect to the sub-scanning direction satisfies ds2=ds1×M where ds1 is a positional difference in the sub-scanning direction between light-emitting units adjacent each other in the main scanning direction in the light-emitting array orthographically-projected on a virtual line extending in the sub-scanning direction, and
the angle α satisfies α=sin⁻¹((ds2/d1)/M) where d1 is a space between adjacent light-emitting units in the light-emitting array with respect to the first direction.

2. The optical scanning device according to claim 1, wherein 1.0≧ds2/d1≧0.5 is satisfied.

3. The optical scanning device according to claim 1, wherein N<M is satisfied.

4. The optical scanning device according to claim 1, wherein ds1 is not less than 1 micrometer and not more than 4 micrometers.

5. The optical scanning device according to claim 1, wherein the light-emitting arrays are vertical-cavity surface-emitting laser arrays.

6. An optical scanning device comprising:
a light source that includes a two-dimensional array of light-emitting units; and
an optical system that scans a target surface with light beams from the light source, wherein
the two-dimensional array include N light-emitting arrays each formed of M light-emitting units arranged equally spaced along a first direction, the first direction tilting from a main scanning direction at an angle α toward a sub-scanning direction,
the light-emitting arrays are equally spaced in the sub-scanning direction, and alternately extend in the first direction from a first position and a second position,
a space ds2 between adjacent light-emitting arrays with respect to the sub-scanning direction satisfies ds2=ds1×M where ds1 is a positional difference in the sub-scanning direction between light-emitting units adjacent each other in the main scanning direction in the light-emitting array orthographically-projected on a virtual line extending in the sub-scanning direction, and
the angle α satisfies α=sin⁻¹((ds2/d1)/M) where d1 is a space between adjacent light-emitting units in the light-emitting array with respect to the first direction.

7. The optical scanning device according to claim 6, wherein a space between the first position and the second position with respect to the main scanning direction is one half of a space between adjacent light-emitting units in the light-emitting array orthographically-projected on a virtual line extending in the main scanning direction.

8. The optical scanning device according to claim 6, wherein ds2/d1≦0.5 is satisfied.

9. The optical scanning device according to claim 6, wherein N<M is satisfied.

10. The optical scanning device according to claim 6, wherein ds1 is not less than 1 micrometer and not more than 4 micrometers.

11. The optical scanning device according to claim 6, wherein the light-emitting arrays are vertical-cavity surface-emitting laser arrays.

12. An image forming apparatus comprising:
an image carrier;
the optical scanning device according to claim 1 that scans the image carrier with the light beams corresponding to image information; and
a transfer device that transfers an image formed on the image carrier onto a transfer medium.

13. An image forming apparatus comprising:
an image carrier;
the optical scanning device according to claim 6 that scans the image carrier with the light beams corresponding to image information; and
a transfer device that transfers an image formed on the image carrier onto a transfer medium.
